(19) United States
(12) Patent Application Publication
(10) Pub. No.: US 2003/0095202 A1
(43) Pub. Date: May 22, 2003

(54) Human vision model based slow motion interpolation

(76) Inventor: Kevin M. Ferguson, Beaverton, OR (US)

Correspondence Address: TEKTRONIX, INC., 14150 S.W. KARL BRAUN DRIVE, P.O. BOX 500 (50-LAW), BEAVERTON, OR, 97077-0001, US

(21) Appl. No.: 09/992,051

(22) Filed: Nov. 21, 2001

(51) Int. Cl. H04N 11/20

(52) U.S. Cl. 348/441; 348/459

(57) ABSTRACT

A human vision model based slow motion interpolation apparatus and method that renders smooth interpolated video at a desired rate from a slower rate video source up-samples the slower rate video to the desired rate. The up-sampled video is input to a human vision model based adaptive filter that has recursive characteristics. The output from the adaptive filter is the smooth interpolated video without a direct current component. A direct current restorer may be used to add to the smooth interpolated video the direct current component from the up-sampled video signal.

### BACKGROUND OF THE INVENTION

The present invention relates to video signal processing, and more particularly to a human vision model based slow motion interpolation apparatus and method that renders smooth interpolated video from a slower rate video source.

In many video applications there is a need to adapt a slow rate video sequence to a higher rate video sequence. Such applications include format conversion between PAL (25 frames per second) to NTSC (30 frames per second), between film (24 frames per second) and one of the television standards, and for presenting slow motion video sequences where the input frame rate is reduced. One of the problems is to avoid apparent “jerkiness” in the converted video sequence where one frame is displayed for two or more display frame periods before the next one is displayed. The prior solution has been to interpolate between frames so that there is an interpolated frame of video for each display frame. Interpolation may take the form of differencing two “anchor” frames and then computing intermediate, interpolated frames using either a linear function, frame repeats, a spline function or the like. None of these prior forms of interpolation have any human vision model components.

What is desired is a human vision model based slow motion interpolation apparatus and method that renders smooth interpolated video from a slower rate video source.

### BRIEF SUMMARY OF THE INVENTION

Accordingly the present invention provides a human vision model based slow motion interpolation apparatus and method that renders smooth interpolated video at a desired rate from a slower rate video source. The slower rate video signal is up-sampled to the desired rate and input to a human vision model based adaptive filter that has recursive characteristics. The output from the adaptive filter is the smooth interpolated video without a direct current component. A direct current (APL—average picture level) restorer may be used to add to the smooth interpolated video the direct current component from the up-sampled video signal.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a human vision model based slow motion interpolation apparatus according to the present invention.

### DETAILED DESCRIPTION OF THE INVENTION

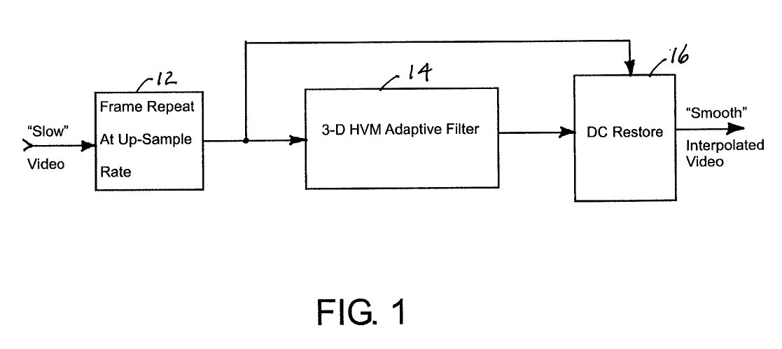

Referring now to FIG. 1 a slower rate or “slow” video signal is input to a frame rate converter 12 that up-samples the slower rate video signal to a desired higher rate video signal. The higher rate video signal is then input to a three-dimensional (3D) human vision model (HVM) adaptive filter 14, such as that described in co-pending U.S. patent application Ser. No. 09/858,775 filed by the present inventor on May 16, 2001 entitled “Adaptive Spatio-Temporal Filter for Human Vision Model Systems.” The output from the HVM adaptive filter 14 is a temporally smooth, not necessarily blurred, interpolated video signal at the higher rate without any direct current (DC) component. The output from the HVM adaptive filter 14 together with the up-sampled slower rate video signal from the frame rate converter 12 are input to a DC restore circuit 16, as the HVM adaptive filter eliminates the DC component of the up-sampled slower rate video signal. The DC restore circuit 16 determines the DC level from the up-sampled slower rate video signal and adds that to the smooth interpolated video signal to produce the final output “smooth” interpolated video signal. In some instances the DC restore circuit 16 may be eliminated. Otherwise the DC level added to the smooth interpolated video signal by the DC restore circuit 16 may be a constant, may be based on average picture level (APL) from the up-sampled slower rate video signal, or may be determined in any other way that is well known in the art.

The HVM adaptive filter 14 is a plurality of filters composed of a common building block, as shown in FIG. 2 of referenced U.S. patent application Ser. No. 09/858,775. This is a recursive filter architecture where the output of the filter is multiplied by a constant less than one, delayed and fed back to the input for combining with the next frame in sequence. The recursive nature of the HVM adaptive filter results in the interpolation of the up-sampled slower rate video signal into the smooth interpolated video signal.

Thus the present invention provides a smooth interpolated video from a slower rate video signal by up-sampling to a desired rate and filtering using a 3D HVM adaptive filter which is recursive in architecture.

What is claimed is:

1. An apparatus for providing a smooth interpolated video signal at a desired rate from a slower rate video signal comprising:
means for up-sampling the slower rate video signal to the desired rate; and
means for adaptively filtering the up-sampled slower rate video signal using a human vision model to produce the smooth interpolated video signal.

2. The apparatus as recited in claim 1 further comprising means for restoring a direct current level for the smooth interpolated video signal.

3. An apparatus for providing a smooth interpolated video signal at a desired rate from a slower rate video signal comprising:
a frame converter for up-sampling the slower rate video signal to produce an up-sampled video signal at the desired rate; and
an adaptive filter based on a human vision model for interpolating the up-sampled video signal to produce the smooth interpolated video signal.

4. The apparatus as recited in claim 3 further comprising an direct current restorer having as inputs the smooth interpolated video signal from the adaptive filter and the up-sampled video signal for restoring a direct current level in the smooth interpolated video signal.

5. A method of providing a smooth interpolated video signal at a desired rate from a slower rate video signal comprising the steps of:
up-sampling the slower rate video signal to the desired rate to produce an up-sampled video signal; and
adaptively filtering the up-sampled video signal according to a human vision model to produce the smooth interpolated video signal.

6. The method as recited in claim 5 further comprising the step of restoring a direct current level in the smooth interpolated video signal as a function of the up-sampled video signal.
